(19) United States
(12) Patent Application Publication
(10) Pub. No.: US 2013/0286107 A1
(43) Pub. Date: Oct. 31, 2013

(54) INKJET PRINT HEAD

(71) Applicant: SAMSUNG ELECTRO-MECHANICS CO., LTD., Suwon (KR)

(72) Inventors: Pil Joong KANG, Suwon (KR); Yoon Sok PARK, Suwon (KR)

(73) Assignee: Samsung Electro-Mechanics Co., Ltd., Suwon (KR)

(21) Appl. No.: 13/766,409

(22) Filed: Feb. 13, 2013

(30) Foreign Application Priority Data
Apr. 27, 2012 (KR) 10-2012-0044833

(51) Int. Cl. B41J 2/045

(52) U.S. Cl. CPC B41J 2/04525
USPC 347/70

(57) ABSTRACT

There is provided an inkjet print head including: a nozzle substrate having a nozzle and a pressure chamber formed therein; and a vibrating substrate coupled to the nozzle substrate and transferring pressure from a piezoelectric actuator to the pressure chamber, wherein the vibrating substrate has a plurality of pores absorbing a pressure wave generated in a process of discharging ink.

### CROSS-REFERENCE TO RELATED APPLICATIONS

This application claims the priority of Korean Patent Application No. 10-2012-0044833 filed on Apr. 27, 2012, in the Korean Intellectual Property Office, the disclosure of which is incorporated herein by reference.

### BACKGROUND OF THE INVENTION

1. Field of the Invention

The present invention relates to an inkjet print head, and more particularly, to an inkjet print head in which cross-talk caused due to a reflection wave (or a pressure wave) generated in a process of discharging ink is significantly reduced.

2. Description of the Related Art

An inkjet print head is a device discharging a predetermined amount of ink through a nozzle.

Generally, an inkjet print head includes a pressure chamber in which ink is stored and an actuator providing driving force required for discharging ink therefrom.

The majority of the driving force (or pressure) generated by the actuator is used to discharge ink contained in the pressure chamber. However, some of the driving force may be transferred to an ink-filled manifold or an ink supply channel to thereby affect the pressure chamber adjacent thereto. This phenomenon, known as “cross-talk,” is intensified as an ink discharge speed or a driving frequency of the inkjet print head is increased.

Related art methods of significantly reducing cross-talk in inkjet print heads are disclosed in Patent Documents 1 and 2.

Patent Document 1 discloses a structure in which a pillar 30 is formed in a common reservoir 11 to reduce a pressure wave, while Patent Document 2 discloses a structure in which filters 22 and 23 are formed in pressure chambers 21 and 24 to absorb a pressure wave.

However, in the structures disclosed in Patent Documents 1 and 2, since the pillar 30 and the filters 22 and 23 excessively hinder ink flow, it is difficult to smoothly supply the ink to the pressure chambers. In addition, in the structures disclosed in Patent Documents 1 and 2, since a separate structure should be formed in the channel through which the ink is supplied, the manufacturing of the inkjet print head may become relatively complicated.

### RELATED ART DOCUMENT

(Patent Document 1) Korean Patent Laid-Open Publication No. 2011-058422 A
(Patent Document 2) Japanese Patent Laid-Open Publication No. 1997-239974 A

### SUMMARY OF THE INVENTION

An aspect of the present invention provides an inkjet print head capable of effectively absorbing or reducing a pressure wave generated in a process of discharging ink.

According to an aspect of the present invention, there is provided an inkjet print head including: a nozzle substrate having a nozzle and a pressure chamber formed therein; and a vibrating substrate coupled to the nozzle substrate and transferring pressure from a piezoelectric actuator to the pressure chamber, wherein the vibrating substrate has a plurality of pores absorbing a pressure wave generated in a process of discharging ink.

The nozzle substrate may include a first nozzle substrate having the nozzle formed therein; and a second nozzle substrate having the pressure chamber formed therein.

The nozzle substrate may include a manifold and a restrictor.

The nozzle substrate may include a first nozzle substrate having the nozzle formed therein; a second nozzle substrate having the pressure chamber and the manifold formed therein; and a third nozzle substrate having the restrictor formed therein, the restrictor connecting the pressure chamber and the manifold to each other.

The pores may be formed by a chemical surface-treatment process.

The pores may have a diameter of 0.5 μm to 20 μm and a depth of 1 μm to 20 μm.

The inkjet print head may further include a channel forming substrate coupled to the vibrating substrate and having an ink supply channel formed therein, the ink supply channel connecting an ink inlet and the pressure chamber to each other.

The channel forming substrate may include a first channel forming substrate having a connecting channel formed therein, the connecting channel connected to the pressure chamber and extended in a thickness direction of the first channel forming substrate; and a second channel forming substrate having the ink supply channel formed therein, the ink supply channel connected to the connecting channel and extended in length and width directions of the second channel forming substrate.

The channel forming substrate may have a plurality of pores absorbing the pressure wave generated in the process of discharging the ink.

The pores of the channel forming substrate may be formed by a chemical surface-treatment process.

According to another aspect of the present invention, there is provided an inkjet print head including: a nozzle substrate having a nozzle and a pressure chamber formed therein; a vibrating substrate coupled to the nozzle substrate and having an actuator attached thereto in order to transfer driving force to the pressure chamber; and a channel forming substrate coupled to the vibrating substrate and having an ink inlet and an ink supply channel formed therein, the ink inlet allowing ink to be introduced therethrough and the ink supply channel connecting the ink inlet and the pressure chamber to each other, wherein the channel forming substrate has a plurality of pores absorbing a pressure wave generated in a process of discharging ink.

The pores may be formed by a chemical surface-treatment process.

The pores may have a diameter of 0.5 μm to 20 μm and a depth of 1 μm to 20 μm.

The ink supply channel may be formed to be elongated in a length direction of the channel forming substrate.

The ink supply channel may have a plurality of pillar members formed therein, the pillar members absorbing the pressure wave generated in the process of discharging the ink.

The plurality of pillar members may have a plurality of pores formed therein, the pores absorbing the pressure wave generated in the process of discharging the ink.

Intervals between the pillar members may be gradually reduced from the ink inlet toward the pressure chamber.

The channel forming substrate may include a first channel forming substrate having a connecting channel formed therein, the connecting channel connected to the pressure chamber and extended in a thickness direction of the first channel forming substrate; and a second channel forming substrate having the ink supply channel formed therein, the ink supply channel connected to the connecting channel and extended in length and width directions of the second channel forming substrate.

The first channel forming substrate may further include a receiving space receiving the actuator therein.

The channel forming substrate may have a through-hole into which a wire electrically connecting the actuator to a driving circuit is inserted.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of an inkjet print head according to an embodiment of the present invention;

FIGS. 2A and 2B are micrographs showing a surface of a vibrating substrate shown in FIG. 1;

FIG. 3 is a cross-sectional view of an inkjet print head according to another embodiment of the present invention;

FIG. 4 is a cross-sectional view of an inkjet print head according to another embodiment of the present invention;

FIG. 5 is a cross-sectional plan view taken along line A-A of the inkjet print head shown in FIG. 4;

FIG. 6 is a cross-sectional view of an inkjet print head according to another embodiment of the present invention;

FIG. 7 is a cross-sectional view of an inkjet print head according to another embodiment of the present invention; and

FIG. 8 is a cross-sectional plan view taken along line B-B of the inkjet print head shown in FIG. 7.

### DETAILED DESCRIPTION OF THE EMBODIMENTS

In order to improve the printing quality of an inkjet print head, intervals between nozzles in the inkjet print head have gradually been narrowed.

For example, commonly used inkjet print heads have recently been changed from a 512 structure (a structure in which 512 nozzles are disposed in a length direction of the inkjet print head) to a 1024 structure (a structure in which 1024 nozzles are disposed in the length direction of the inkjet print head).

However, as the intervals between the nozzles are narrowed, cross-talk caused due to a pressure wave (or a reflection wave) generated in a process of discharging ink has been generated. For reference, the cross-talk phenomenon described in the present specification refers to a phenomenon in which a certain amount of pressure applied to a pressure chamber is transferred to a common channel (for example, a manifold) through which the ink is supplied to thereby affect a pressure chamber adjacent thereto, and the terms “pressure wave” and “reflection wave” are used as terms indicating ink flow or impact energy transferred from the pressure chamber toward the common channel.

In order to suppress this cross-talk phenomenon, an inkjet print head capable of absorbing the pressure wave causing the cross-talk phenomenon may be provided.

To this end, pores may be formed in at least one substrate configuring the inkjet print head. Here, the pores formed in the substrate may have a regular shape or an irregular shape.

In addition, the pores may be formed by performing a chemical surface-treatment or mechanical machining on the substrate.

The pores formed as described above may absorb a pressure wave generated in the process of discharging ink to significantly reduce or suppress the generation of the cross-talk phenomenon.

Hereinafter, embodiments of the present invention will be described in detail with reference to the accompanying drawings.

In describing the present invention below, terms indicating components of the present invention are used in consideration of the functions of individual components. Therefore, the terms should not be understood as limiting technical components of the present invention.

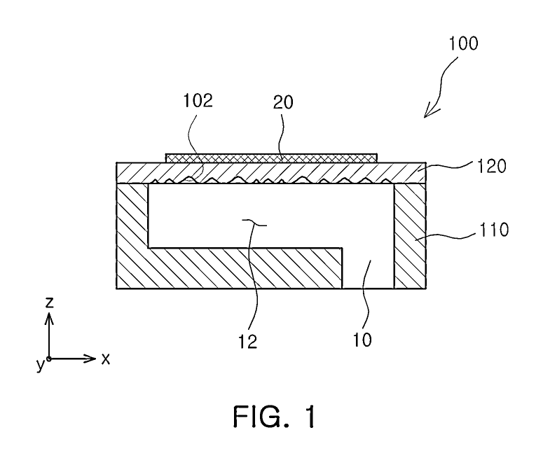

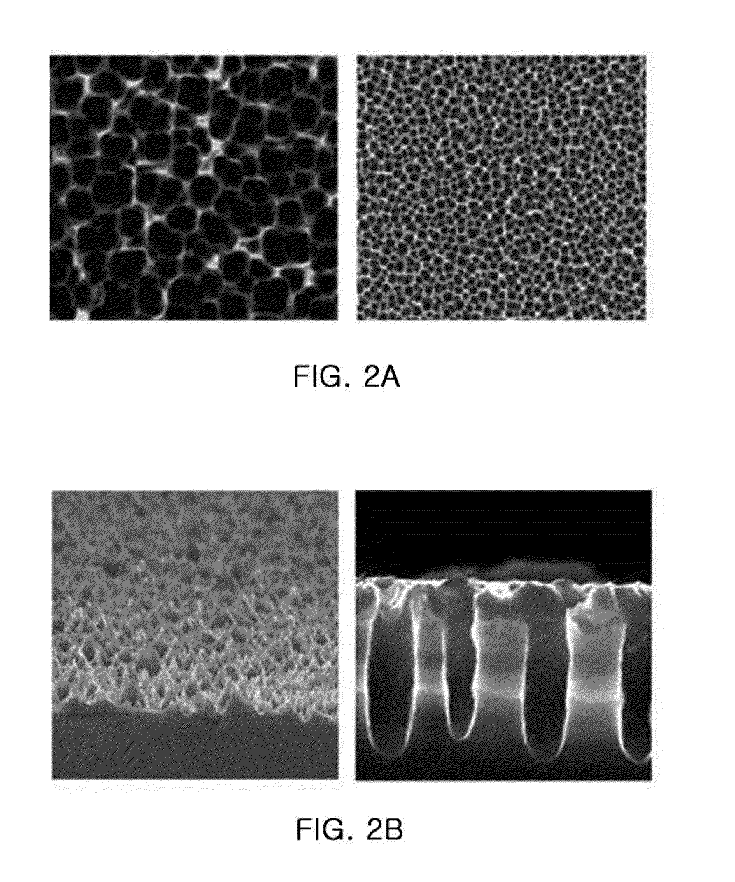

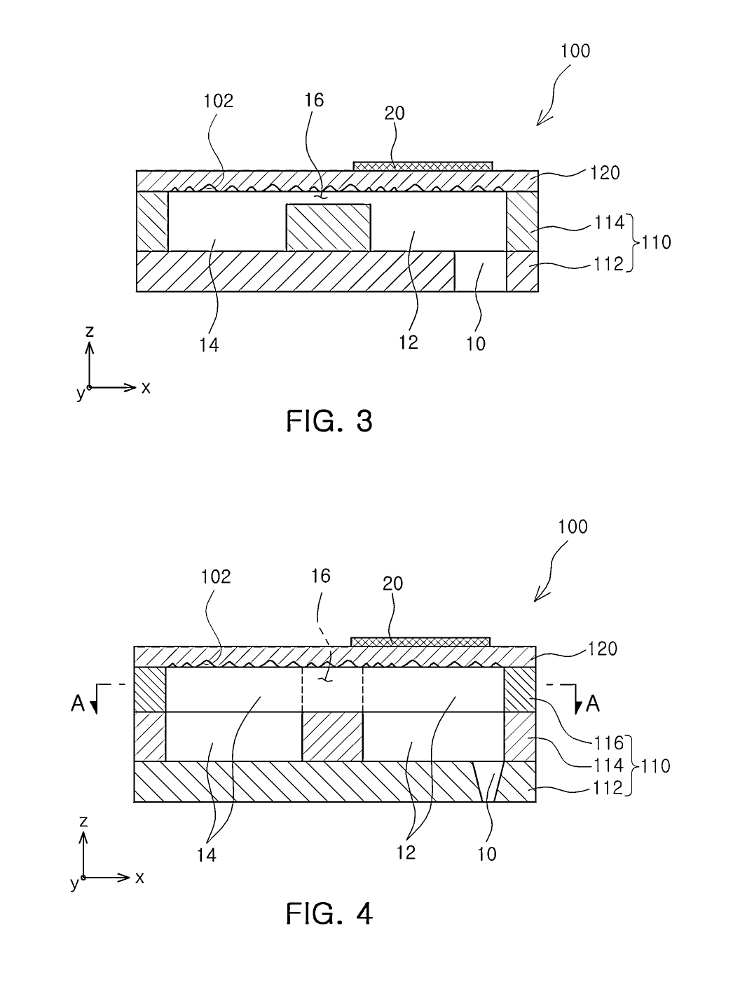

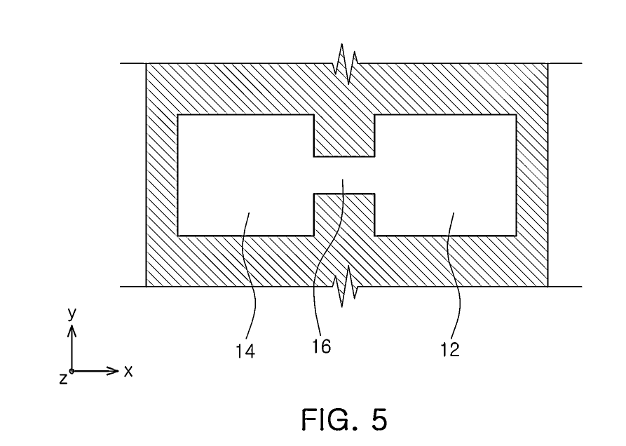

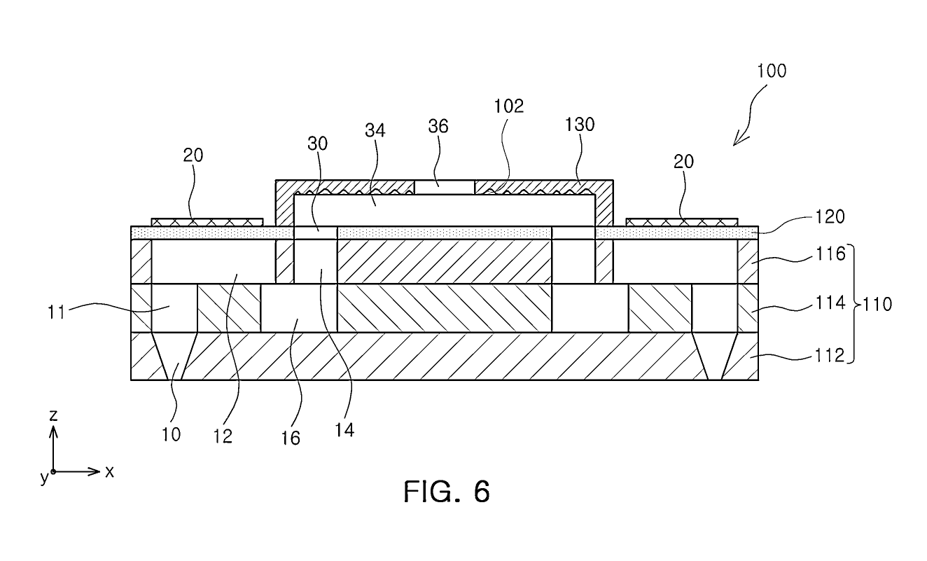

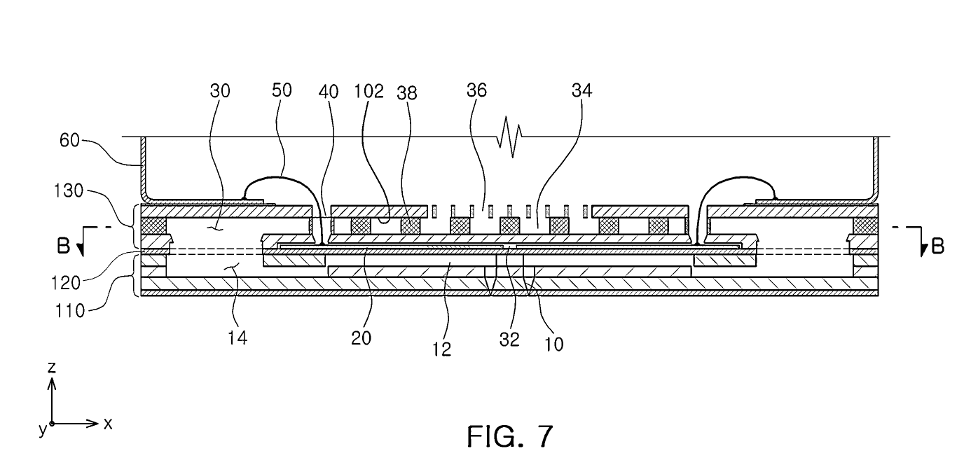

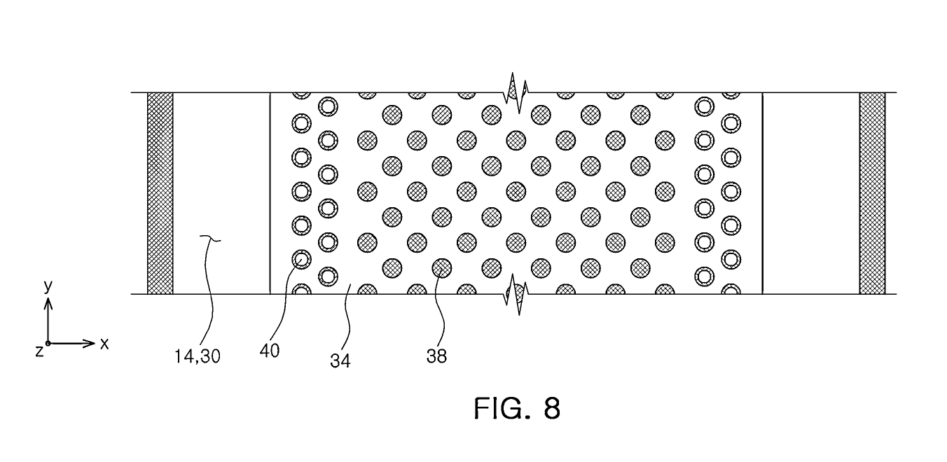

FIG. 1 is a cross-sectional view of an inkjet print head according to an embodiment of the present invention; FIGS. 2A and 2B are micrographs showing a surface of a vibrating substrate shown in FIG. 1; FIG. 3 is a cross-sectional view of an inkjet print head according to another embodiment of the present invention; FIG. 4 is a cross-sectional view of an inkjet print head according to another embodiment of the present invention; FIG. 5 is a cross-sectional plan view taken along line A-A of the inkjet print head shown in FIG. 4; FIG. 6 is a cross-sectional view of an inkjet print head according to another embodiment of the present invention; FIG. 7 is a cross-sectional view of an inkjet print head according to another embodiment of the present invention; and FIG. 8 is a cross-sectional plan view taken along line B-B of the inkjet print head shown in FIG. 7.

For reference, in the accompanying drawings, an X axis direction refers to a width direction of the inkjet print head, a Y axis direction refers to a length direction of the inkjet print head, and a Z axis direction refers to a thickness direction of the inkjet print head.

An inkjet print head according to an embodiment of the present invention will be described with reference to FIGS. 1 through 2B.

An inkjet print head 100 may include a nozzle substrate 110 and a vibrating substrate 120.

The nozzle substrate 110 may be formed of a single crystalline silicon substrate. However, the nozzle substrate 110 may be formed of a silicon on insulator (SOI) substrate or a laminated substrate in which a silicone substrate and a plurality of insulation members are laminated, as needed.

The nozzle substrate 110 may have nozzles 10 and pressure chambers 12 formed therein.

The nozzles 10 may be formed at predetermined intervals in a length direction (a Y axis direction based on FIG. 1) of the inkjet print head 100. For example, 1024 nozzles 10 may be formed at predetermined intervals in the length direction of the inkjet print head 100.

In addition, the plurality of nozzles 10 may be formed in a plurality of rows in a width direction (an X axis direction based on FIG. 1) of the inkjet print head 100. For example, the nozzles 10 may be formed in two rows in the width direction of the inkjet print head 100.

The nozzle 10 may have a shape in which a cross-sectional area thereof is changed in a thickness direction of the nozzle substrate 110. For example, the nozzle 10 may have a shape in which a cross-sectional area thereof is gradually reduced toward the Z axis. However, the shape of the nozzle 10 is merely an example and is not limited thereto. Therefore, the nozzle 10 may have a hole shape in which it has the same cross-sectional size as shown in FIG. 1.

The pressure chamber 12 may have a predetermined volume. For example, the pressure chamber 12 may have a volume equal to or larger than a single discharge amount of the ink. Here, the former may be advantageous for fixed quantity discharging of ink and the latter may be advantageous for continuous discharging of ink.

The pressure chamber 12 may be formed in the thickness direction (a Z axis direction) of the nozzle substrate 110 and be connected to the nozzle 10.

The pressure chambers 12 may be formed at predetermined intervals in the length direction (the Y axis direction) and in the width direction (the X axis direction) of the inkjet print head 100, similar to the nozzles 10.

The vibrating substrate 120 may be formed of a single crystalline silicon substrate, similar to the nozzle substrate 110. However, the vibrating substrate 120 may be formed of a silicon on insulator (SOI) substrate or a laminated substrate in which a silicone substrate and a plurality of insulation members are laminated, as needed. In addition, the vibrating substrate 120 and the nozzle substrate 110 may be formed of different materials. The vibrating substrate 120 may be coupled to the nozzle substrate 110 and transfer driving force of the actuator 20 to the pressure chamber 12.

The vibrating substrate 120 may include pores 102 formed therein. For example, the vibrating substrate 120 may include a plurality of pores 102 formed in a lower surface thereof (based on FIG. 1).

The pores 102 may have a predetermined depth or diameter. For example, the pores 102 may have a diameter of 0.5 to 20 μm and a depth of 1 to 20 μm.

The pores 102 may be formed by a chemical surface-treatment process or a mechanical machining process. For example, the pores 102 may be formed by treating the surface of the vibrating substrate 120 with an etching solution. Alternatively, the pores 102 may be formed by mechanically machining (for example, polishing) the surface of the vibrating substrate 120.

The pores 102 formed as described above may have an irregular shape as shown in FIGS. 2A and 2B.

The vibrating substrate 120 may have the actuator 20 mounted thereon.

The actuator 20 may be formed on an upper surface (based on FIG. 1) of the vibrating substrate 120. More specifically, the actuator 20 may be formed in a position corresponding to the pressure chamber 12 on the upper surface of the vibrating substrate 120.

The actuator 20 may include a piezoelectric element and upper and lower electrode members. More specifically, the actuator 20 may have a laminated structure in which the piezoelectric element is disposed between the upper and lower electrode members.

The lower electrode member may be formed on the upper surface of the vibrating substrate 120 and be formed of at least one conductive metal material. For example, the lower electrode member may be formed of two metal materials containing titanium (Ti) and platinum (Pt).

The piezoelectric element may be formed on the lower electrode member. More specifically, the piezoelectric element may be thinly formed on a surface of the lower electrode member by screen printing, sputtering, or the like. The piezoelectric element may be formed of a piezoelectric material. For example, the piezoelectric element may be formed of a ceramic (for example, PZT) material.

The upper electrode member may be formed on an upper surface of the piezoelectric element. The upper electrode member may be formed of any one material selected from the group consisting of Pt, Au, Ag, Ni, Ti, Cu, and the like.

The actuator 20 may be expanded and contracted according to an electrical signal to provide driving force for discharging ink from the pressure chamber 12.

The inkjet print head 100 includes the pressure chamber 12 formed by the nozzle substrate 110 and the vibrating substrate 120 having the pores 102 formed therein, thereby absorbing a pressure wave generated in a process of discharging ink.

That is, the inkjet print head 100 according to the embodiment of the present invention absorbs the pressure wave generated in the pressure chamber 12 through the pores 102 of the vibrating substrate 120, thereby suppressing the generation of cross-talk.

Therefore, according to the present embodiment, the plurality of nozzles may be densely formed in the inkjet print head 100, and the generation of the cross-talk phenomenon may be significantly reduced or suppressed.

Further, according to the present embodiment, since a shape of an ink supply channel is not changed or a separate structure is not formed in the ink supply channel in order to reduce the pressure wave, the inkjet print head may be easily manufactured.

Hereinafter, other embodiments of the present embodiment will be described. For reference, in the following embodiments of the present invention, components that are the same as those of the previous embodiment of the present invention will be denoted by the same reference numerals and a detailed description thereof will be omitted.

An inkjet print head 100 according to another embodiment of the present invention will be described with reference to FIG. 3.

According to this embodiment of the present invention, a nozzle substrate 110 may include a first nozzle substrate 112 and a second nozzle substrate 114.

The first and second nozzle substrates 112 and 114 may be formed of the same material and be stacked and coupled to each other in a vertical direction to form a single nozzle substrate 110.

The first nozzle substrate 112 may have nozzles 10 formed therein.

The nozzle 10 may be formed in a thickness direction (a Z axis direction based on FIG. 3) of the first nozzle substrate 112. The nozzle 10 may be formed by an etching process performed on the first nozzle substrate 112.

The second nozzle substrate 114 may have pressure chambers 12, manifolds 14, and restrictors 16 formed therein. Here, the pressure chamber 12, the manifold 14, and the restrictor 16 may be formed by an etching process of the second nozzle substrate 114.

The pressure chamber 12 may be formed in a thickness direction (the Z axis direction based on FIG. 3) of the second nozzle substrate 114. For example, a depth of the pressure chamber 12 may be the same as a thickness of the second nozzle substrate 114.

The pressure chamber 12 may be connected to the nozzle 10 in a state in which the first and second nozzle substrates 112 and 114 are coupled to each other.

The manifold 14 may be formed in the thickness direction of the second nozzle substrate 114. For example, a depth of the manifold 14 may be the same as the thickness of the second nozzle substrate 114.

The manifold 14 may be formed to be elongated in a length direction (a Y axis direction based on FIG. 3) of the second nozzle substrate 114. The manifold 14 may be disposed to be spaced apart form the pressure chamber 12. The manifold 14 may store ink supplied from an ink inlet therein and supply the ink to at least one pressure chamber 12 through the restrictor 16.

The restrictor 16 may be formed between the pressure chamber 12 and the manifold 14 and connect the pressure chamber 12 and the manifold 14 to each other. The restrictor 16 may control a flow rate of the ink supplied from the manifold 14 to the pressure chamber 12.

A vibrating substrate 120 may be formed of the same material as that of the first or second nozzle substrate 112 or 114. The vibrating substrate 120 may include a plurality of pores 102 formed in one surface thereof, similar to the above-mentioned embodiment of the present invention.

The vibrating substrate 120 may be coupled to the second nozzle substrate 114 and transfer driving force of an actuator 20 to the pressure chamber 12.

The vibrating substrate 120 may completely close upper surfaces of the pressure chamber 12, the manifold 14, and the restrictor 16 in a state in which it is coupled to the second nozzle substrate 114. Therefore, the ink stored in the pressure chamber 12, the manifold 14, and the restrictor 16 may always be in contact with one surface (that is, a surface in which the pores 102 are formed) of the vibrating substrate 120.

In the inkjet print head 100 configured as described above, since a contact area between the ink stored in the nozzle substrate 110 and the pores 102 of the vibrating substrate 120 is relatively large, a pressure wave generated in a process of discharging the ink may be effectively suppressed.

Hereinafter, an inkjet print head according to another embodiment of the present invention will be described with reference to FIGS. 4 and 5.

According to this embodiment of the present invention, a nozzle substrate 110 may include a first nozzle substrate 112, a second nozzle substrate 114, and a third nozzle substrate 116.

The first nozzle substrate 112 may include a plurality of nozzles 10. For example, the plurality of nozzles 10 may be formed in a thickness direction (a Z axis direction based on FIG. 4) of the first nozzle substrate 112. The nozzles 10 may be formed by an etching process performed on the first nozzle substrate 112.

The second nozzle substrate 114 may be coupled to the first nozzle substrate 112 and be formed of the same material as that of the first nozzle substrate 112. However, the material of the second nozzle substrate 114 is not limited to that of the first nozzle substrate 112.

The second nozzle substrate 114 may have pressure chambers 12 and manifolds 14 formed therein. Here, the pressure chamber 12 and the manifold 14 may be formed by an etching process performed on the second nozzle substrate 114.

The pressure chamber 12 may be formed in a thickness direction (the Z axis direction based on FIG. 4) of the second nozzle substrate 114. For example, a depth of the pressure chamber 12 may be the same as a thickness of the second nozzle substrate 114.

The pressure chamber 12 may be connected to the nozzle 10 in a state in which the first and second nozzle substrates 112 and 114 are coupled to each other.

The manifold 14 may be formed in the thickness direction of the second nozzle substrate 114. For example, a depth of the manifold 14 may be the same as the thickness of the second nozzle substrate 114.

The manifold 14 may be formed to be elongated in a length direction (a Y axis direction based on FIG. 4) of the second nozzle substrate 114. The manifold 14 may be disposed to be spaced apart form the pressure chamber 12. The manifold 14 may store ink supplied from an ink inlet therein and supply the ink to at least one pressure chamber 12 through a restrictor 16.

The third nozzle substrate 116 may be coupled to the second nozzle substrate 114 and be formed of the same material as that of the first or second nozzle substrate 112 or 114.

However, the material of the third nozzle substrate 116 is not limited to that of the first or second nozzle substrate 112 or 114.

The third nozzle substrate 116 may include the restrictor 16 formed therein. For example, the third nozzle substrate 116 may include a portion of the pressure chamber 12, a portion of the manifold 14, and the restrictor 16 formed therein, as shown in FIG. 5. Here, the pressure chamber 12, the manifold 14, and the restrictor 16 may be formed by an etching process performed on the third nozzle substrate 116.

The third nozzle substrate 116 may be coupled to the second nozzle substrate 14 to complete the shapes of the pressure chamber 12 and the manifold 14.

A vibrating substrate 120 may be coupled to the third nozzle substrate 116 and transfer driving force of an actuator 20 to the pressure chamber 12.

The vibrating substrate 120 may completely close upper surfaces of the pressure chamber 12, manifold 14, and the restrictor 16 in a state in which it is coupled to the third nozzle substrate 116. Therefore, the ink stored in the pressure chamber 12, the manifold 14, and the restrictor 16 may always be in contact with one surface (that is, a surface in which the pores 102 are formed) of the vibrating substrate 120, similar to the previous embodiment of the present invention.

In the inkjet print head 100 configured as described above, since the restrictor 16 is formed in a separate substrate (the third nozzle substrate 116), it may be easy to precisely process the restrictor 16.

Further, according to the present embodiment, since a contact area between the pores 102 of the vibrating substrate 102 and the ink may be arbitrarily adjusted by changing an etching shape (See FIG. 5) of the third nozzle substrate 116, the inkjet print head is significantly less affected by the pressure wave.

Hereinafter, an inkjet print head 100 according to another embodiment of the present invention will be described with reference to FIG. 6.

The inkjet print head 100 according to this embodiment of the present invention may further include a channel forming substrate 130 and have a horizontally symmetrical structure (based on FIG. 6).

A nozzle substrate 110 may include a first nozzle substrate 112, a second nozzle substrate 114, and a third nozzle substrate 116.

The first nozzle substrate 112 may have nozzles 10 formed therein, and the second nozzle substrate may have dampers 11 and restrictors 16 formed therein. In addition, the third nozzle substrate 116 may have pressure chambers 12 and manifolds 14 formed therein.

A vibrating substrate 120 may be coupled to the third nozzle substrate 116 and transfer driving force of an actuator 20 to the pressure chamber 12.

The vibrating substrate 120 may have connecting channels 30 formed therein. The connecting channel 30 may connect the manifold 14 and an ink supply channel 34 to each other.

The vibrating substrate 120 may include pores formed in one surface thereof (an upper surface based on FIG. 6). However, the formation of the pores may be omitted as needed.

The channel forming substrate 130 may be coupled to the vibrating substrate 120 and be configured of a plurality of substrates.

The channel forming substrate 130 may have the ink supply channels 34 and ink inlets 36 formed therein.

The ink supply channel 34 may be formed to be elongated in width and length directions of the channel forming substrate 130 and be connected to the connecting channel 30 of the vibrating substrate 120.

The ink supply channel 34 may include pores 102 formed therein.

The pores 102 may be formed by chemically treating a surface of the channel forming substrate 130 or by mechanically machining (for example, polishing) the surface of the channel forming substrate 130. The pores 102 may absorb a pressure wave generated in a process of discharging ink as described in the above-mentioned embodiments.

Meanwhile, the inkjet print head 100 according to the present embodiment may be advantageous in discharging a fixed quantity of ink, since the pores 102 are not formed in the pressure chamber 12, the manifold 14, and the restrictor 16.

Further, the inkjet print head 100 according to present embodiment may significantly increase a pressure wave suppression or absorption effect since the pores 102 are widely formed over the entire region of the ink supply channel 34.

In addition, in the inkjet print head 100 according to the present embodiment, since the pores 102 are only formed in the channel forming substrate 130 having a relatively simple channel structure, a process of forming the pores 102 may be easily performed.

Hereinafter, an inkjet print head 100 according to another embodiment of the present invention will be described with reference to FIGS. 7 and 8.

The inkjet print head 100 according to the present embodiment may be different from the inkjet print head in terms of a structure of a channel forming substrate 130, according to the previous embodiment of the present invention. For example, according to the present embodiment, the channel forming substrate 130 may cover the entire upper portion of a vibrating substrate 120 and include a plurality of pillar members 38 for reducing a pressure wave.

The channel forming substrate 130 may cover the entire upper portion of the vibrating substrate 120. To this end, the channel forming substrate 130 may include a receiving space 32 receiving an actuator 20 therein and a through-hole 40 into which a bonding wire 50 or an electrical wiring is inserted. For reference, the bonding wire 50 may be a connecting member connecting the actuator 20 and a driving circuit 60 to each other.

The channel forming substrate 130 may include the plurality of pillar members 38 as shown in FIG. 8.

The pillar members 38 may be formed in the ink supply channel 34. More specifically, the pillar members 38 may be disposed to become gradually denser from an ink inlet 36 toward a connecting channel 30.

The pillar member 38 may include a plurality of pores formed therein. The pores of the pillar member 38 may be formed by a chemical surface-treatment process, similar to the pores 102 of the ink supply channel 34. For example, the pores formed in the pillar member 38 may have a diameter of 0.5 to 20 μm and a depth of 1 to 20 μm.

The channel forming substrate 130 may be configured of a plurality of substrates. For example, the channel forming substrate 130 may be configured of a first channel forming substrate having the connecting channel 30 formed therein and a second channel forming substrate having the ink supply channel formed therein. Alternatively, the channel forming substrate 130 may be configured of a first channel forming substrate having the connecting channel 30 formed therein, a second channel forming substrate having the ink supply channel 34 and the pillar member 38 formed therein, and a third channel forming substrate having the ink inlet 36 formed therein. However, the number of channel forming substrates is not limited thereto. Therefore, the channel forming substrate 130 may be configured of a single substrate or of four or more substrates, as needed.

The channel forming substrate 130 may more effectively absorb the pressure wave through the pores of the ink supply channel 34, the pillar member 38, and the pores of the pillar member 38.

Therefore, the inkjet print head 100 according to the present embodiment may significantly reduce cross-talk caused by the pressure wave generated in the process of discharging ink and may discharge a fixed quantity of ink.

As set forth above, in an inkjet print head according to embodiments of the present invention, a pressure wave generated in a process of discharging ink may be effectively absorbed or reduced.

Therefore, a uniform quality of printing resolution may be obtained, regardless of a driving frequency of the inkjet print head.

While the present invention has been shown and described in connection with the embodiments, it will be apparent to those skilled in the art that modifications and variations can be made without departing from the spirit and scope of the invention as defined by the appended claims.

What is claimed is:

1. An inkjet print head comprising:
a nozzle substrate having a nozzle and a pressure chamber formed therein; and
a vibrating substrate coupled to the nozzle substrate and transferring pressure from a piezoelectric actuator to the pressure chamber,
wherein the vibrating substrate has a plurality of pores absorbing a pressure wave generated in a process of discharging ink.

2. The inkjet print head of claim 1, wherein the nozzle substrate includes:
a first nozzle substrate having the nozzle formed therein; and
a second nozzle substrate having the pressure chamber formed therein.

3. The inkjet print head of claim 1, wherein the nozzle substrate includes a manifold and a restrictor.

4. The inkjet print head of claim 3, wherein the nozzle substrate includes:
a first nozzle substrate having the nozzle formed therein;
a second nozzle substrate having the pressure chamber and the manifold formed therein; and
a third nozzle substrate having the restrictor formed therein, the restrictor connecting the pressure chamber and the manifold to each other.

5. The inkjet print head of claim 1, wherein the pores are formed by a chemical surface-treatment process.

6. The inkjet print head of claim 1, wherein the pores have a diameter of 0.5 μm to 20 μm and a depth of 1 μm to 20 μm.

7. The inkjet print head of claim 1, further comprising a channel forming substrate coupled to the vibrating substrate and having an ink supply channel formed therein, the ink supply channel connecting an ink inlet and the pressure chamber to each other.

8. The inkjet print head of claim 7, wherein the channel forming substrate includes:
a first channel forming substrate having a connecting channel formed therein, the connecting channel connected to the pressure chamber and extended in a thickness direction of the first channel forming substrate; and
a second channel forming substrate having the ink supply channel formed therein, the ink supply channel connected to the connecting channel and extended in length and width directions of the second channel forming substrate.

9. The inkjet print head of claim 7, wherein the channel forming substrate has a plurality of pores absorbing the pressure wave generated in the process of discharging the ink.

10. The inkjet print head of claim 9, wherein the pores of the channel forming substrate are formed by a chemical surface-treatment process.

11. An inkjet print head comprising:
a nozzle substrate having a nozzle and a pressure chamber formed therein;
a vibrating substrate coupled to the nozzle substrate and having an actuator attached thereto in order to transfer driving force to the pressure chamber; and
a channel forming substrate coupled to the vibrating substrate and having an ink inlet and an ink supply channel formed therein, the ink inlet allowing ink to be introduced therethrough and the ink supply channel connecting the ink inlet and the pressure chamber to each other,
wherein the channel forming substrate has a plurality of pores absorbing a pressure wave generated in a process of discharging ink.

12. The inkjet print head of claim 11, wherein the pores are formed by a chemical surface-treatment process.

13. The inkjet print head of claim 11, wherein the pores have a diameter of 0.5 μm to 20 μm and a depth of 1 μm to 20 μm.

14. The inkjet print head of claim 11, wherein the ink supply channel is formed to be elongated in a length direction of the channel forming substrate.

15. The inkjet print head of claim 11, wherein the ink supply channel has a plurality of pillar members formed therein, the pillar members absorbing the pressure wave generated in the process of discharging the ink.

16. The inkjet print head of claim 15, wherein the plurality of pillar members have a plurality of pores formed therein, the pores absorbing the pressure wave generated in the process of discharging the ink.

17. The inkjet print head of claim 15, wherein intervals between the pillar members are gradually reduced from the ink inlet toward the pressure chamber.

18. The inkjet print head of claim 15, wherein the channel forming substrate includes:
a first channel forming substrate having a connecting channel formed therein, the connecting channel connected to the pressure chamber and extended in a thickness direction of the first channel forming substrate; and
a second channel forming substrate having the ink supply channel formed therein, the ink supply channel connected to the connecting channel and extended in length and width directions of the second channel forming substrate.

19. The inkjet print head of claim 18, wherein the first channel forming substrate further includes a receiving space receiving the actuator therein.

20. The inkjet print head of claim 11, wherein the channel forming substrate has a through-hole into which a wire electrically connecting the actuator to a driving circuit is inserted.
